(19) United States
(12) Patent Application Publication
(10) Pub. No.: US 2026/0138267 A1
(43) Pub. Date: May 21, 2026

(54) Soft Robotic Gripper Actuated by Artificial Muscles

(71) Applicant: Wayne State University, Detroit, MI (US)

(72) Inventors: Yara Almubarak, Detroit, MI (US); Mohammed Anteet, Detroit, MI (US); Angel Kitone, Clinton Twp., MI (US)

(21) Appl. No.: 19/395,187

(22) Filed: Nov. 20, 2025

Related U.S. Application Data
(60) Provisional application No. 63/723,226, filed on Nov. 21, 2024.

(51) Int. Cl. B25J 9/10; B25J 13/02; B25J 15/10; G05D 23/24; H05B 1/02

(52) U.S. Cl. CPC B25J 9/1085; B25J 9/1075; B25J 13/025; B25J 15/103; G05D 23/24; H05B 1/023

(57) ABSTRACT

A soft robotic gripper includes multiple fingers, each embedding at least one artificial muscle formed as a low-temperature shape-memory coil that recovers a memorized shape when electrically heated, thereby driving the fingers between open and gripping configurations in cold environments; the coil acts as a Joule-heated actuator enabling reversible contraction/extension with improved response at reduced transformation temperatures suitable for low-ambient operation.

### CROSS REFERENCE TO RELATED APPLICATION

This application claims the benefit of U.S. Provisional Patent Application No. 63/723,226, filed Nov. 21, 2024, which is incorporated by reference herein in its entirety.

### TECHNICAL FIELD

This disclosure relates to devices, systems, and methods for sample collection. More specifically, it concerns sampling technologies that utilize a soft robotic gripper actuated by artificial muscles, engineered for dependable performance in low-temperature environments encountered in terrestrial, aerospace, and marine exploration applications.

### BACKGROUND

The advancement of the various exploration applications relies on developing adaptable robotic systems capable of enduring diverse environmental conditions and unknown topographies. Traditional hydraulic based vehicle grippers and manipulators face significant challenges in high-pressure, extreme cold temperatures, and corrosive marine settings due to mechanical susceptibility to early failure. Their rigid and heavy structures limit access to delicate spaces, require large power supplies, and often disrupt habitats, hindering precise sampling and data collection.

Traditional manipulators and grippers used in marine exploration typically rely on hydraulic systems for movement. These hydraulic systems are prone to mechanical failure under extreme pressure and temperature conditions. The seals, pumps, and hoses necessary for hydraulic operation can leak or fail at high depths due to the intense pressure of the deep sea (e.g., at pressures of about 16,000 psi or greater), resulting in reduced reliability and operational lifespan. Moreover, hydraulic fluid is susceptible to changes in temperature, which can affect the performance of the robotic arms, making them less predictable and controllable.

Traditional hydraulic systems are also typically large and heavy, which limits their ability to access confined or delicate underwater environments. This bulkiness increases the energy consumption of Autonomous Underwater Vehicles (AUVs) or Remotely Operated Vehicles (ROVs), requiring larger power supplies and reducing the overall efficiency of the exploration missions.

The rigid and mechanical nature of hydraulic-based grippers and manipulators makes them ill-suited for delicate operations. They risk disturbing or damaging fragile ecosystems during sampling, an especially critical issue when the goal is to study sensitive or rare marine organisms and habitats. Their limited flexibility and lack of fine control further exacerbate the issue, often leading to imprecise sampling.

Biomimetic robotic structures, inspired by the efficient and durable movements of marine organisms, offer a promising solution. These flexible designs allow for delicate maneuvering in extreme underwater conditions, overcoming the limitations of conventional rigid manipulators. Despite recent advances, existing biomimetic studies lack a comprehensive, ocean-deployable soft robotic gripper with multifunctional capabilities akin to current hydraulic based manipulators attached to autonomous underwater vehicles (AUVs), remotely operated underwater vehicles (ROVs) or human occupied vehicles (HOVs).

### SUMMARY

A first aspect of the disclosure provides a gripper that includes multiple fingers. Each finger contains at least one artificial muscle, which comprises at least one low-temperature shape-memory coil. The coil is configured to return to a memorized shape when electrical power is applied, allowing the finger to transition between open and gripping positions even in cold environments (e.g., environment with a temperature no greater than 4° C.).

Implementations of the disclosure may include one or more of the following optional features. In some implementations, the low-temperature shape-memory coil includes a nickel-titanium (NiTi) alloy, with a transformation temperature selectable between approximately 1° C. and 60° C.

In one example, the low-temperature shape-memory coil includes NiTi alloy with a transformation temperature of approximately 34° C. The fingers can conformally wrap around a regular or irregular objects during a gripping operation to secure samples, leveraging finger compliance and distributed actuation to improve contact stability over varied geometries. Each finger can be coupled to a linkage of a manipulator through a joint to enable rotational motion and compliant alignment during approach and grasp.

In some implementations, the joint is a ball-and-socket joint. In some implementations, the joint is a spring-integrated joint.

In some implementations, a voltage of the electrical power applied to the artificial muscle is between approximately 2 V and 5 V to induce Joule heating.

In one configuration, the electrical power is less than 70 W (e.g., approximately 13 W) for an artificial muscle, supporting practical thermal rise and contraction under compact power electronics.

In some implementations, the gripper can further include a detector, configured to measure temperature and electrical resistance of the artificial muscle, and at least one processor configured to increase, decrease, apply, remove, or maintain the electrical power to the artificial muscle based on at least one of the measured temperature or measured resistance to maintain a gripping configuration.

In some implementations, the gripper can further include a detector and at least one processor configured to generate a haptic feedback signal derived from at least one of the measured temperature or measured electrical resistance.

A second aspect of the disclosure provides a feedback-control system for controlling at least one artificial muscle of a manipulator in a cold environment, including at least one processor and a non-transitory computer-readable medium storing instructions that cause the system to receive a temperature measurement from a detector, compare the temperature to a transformation temperature of the artificial muscle, and, in response to determining that the muscle temperature is greater than the transformation temperature, generate a first control signal to a power supply to decrease or discontinue electrical power, with the transformation temperature constrained to be no greater than 60° C.

Implementations of the disclosure may include one or more of the following optional features.

In some implementations, in response to determining that the artificial muscle temperature is less than the transformation temperature, the system can generate a second control signal to increase electrical power delivered to the artificial muscle to induce transformation and returning it to its memorized shape.

In some implementations, the stored instructions further cause the system to receive a resistance measurement from the detector, compare the measured resistance to a resistance value corresponding to the transformation temperature, and, when the measured resistance exceeds the corresponding value, generate the first control signal to reduce or discontinue the power to the artificial muscle.

In some implementations, conversely, when the measured resistance is less than the resistance value corresponding to the transformation temperature, the system can generate the second control signal to increase electrical power delivered to the artificial muscle.

In some implementations, the processor analyzes temperature measurement and resistance measurement and, based on that analysis, generates and transmits a warning message to a user (e.g., via controller, via display, via speaker) indicating a malfunction of the artificial muscles. For example, when the temperature derived from the resistance measurement and the temperature measurement differ by more than A % (for example, 10%), the data analytics engine generates and sends a warning message to the user. This can help the user to locate potential malfunctioning artificial muscles.

In some implementations, the artificial muscle for the feedback-control system can include at least one low-temperature shape-memory coil comprising NiTi alloy.

A third aspect of the disclosure provides a haptic feedback system for controlling at least one artificial muscle of a manipulator in a cold environment, including at least one processor and a non-transitory computer-readable medium storing instructions to receive a temperature measurement from a detector, compare the temperature to a transformation temperature, and, in response to determining that the temperature exceeds the transformation temperature, generate a haptic signal to a haptic actuator, wherein the transformation temperature is no greater than 60° C. and the artificial muscle includes at least one NiTi low-temperature shape-memory coil.

Implementations of the disclosure may include one or more of the following optional features.

In some implementations, when the temperature of the artificial muscle is greater than the transformation temperature and is increasing, the system increases the amplitude of the haptic signal to convey actuator thermal trend and state progression.

In some implementations, the stored instructions can further cause the system to receive a resistance measurement of the artificial muscle, compare the resistance to a resistance value corresponding to the transformation temperature, and generate the haptic signal when the resistance exceeds the resistance value.

In some examples, when the resistance measurement is greater than the resistance value and increasing, the system increases the haptic signal amplitude.

A fourth aspect of the disclosure provides a method for controlling at least one artificial muscle of a manipulator in a cold environment, according to the second aspect, including implementations thereof.

A fifth aspect of the disclosure provides a method for controlling at least one artificial muscle of a manipulator in a cold environment, according to the third aspect, including implementations thereof.

A sixth aspect of the disclosure provides a method for controlling a gripper according to the first aspect, including implementations thereof.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a gripper incorporating artificial muscles embedded within fingers of the gripper in accordance with some implementations of this disclosure.

FIG. 2 illustrates the shape change of the gripper in response to changes in the temperature of the artificial muscles embedded within the fingers of the gripper.

FIG. 3 is a schematic view of the gripper (e.g., bio-inspired gripper) configured to wrap around an object (e.g., irregular object) for sampling in accordance with some implementations of this disclosure.

FIG. 4 is a schematic view of an electrically driven underwater manipulator configured with the gripper at the distal end of the manipulator in accordance with some implementations of this disclosure.

FIG. 5A and FIG. 5B depict a portion of the manipulator configured with an exemplary ball-and-socket joint operatively coupling a second linkage to a third linkage, corresponding to the linkages shown in FIG. 4.

FIG. 6A provides a perspective view of a portion of a manipulator in accordance with some implementations of this disclosure.

FIG. 6B provides a side view of the portion of the manipulator in accordance with some implementations of this disclosure.

FIG. 6C provides a perspective view of a spring-integrated joint of the manipulator in accordance with some implementations of this disclosure.

FIG. 6D provides a top view of the spring-integrated joint of the manipulator in accordance with some implementations of this disclosure.

FIG. 6E provides a bottom view of the spring-integrated joint of the manipulator in accordance with some implementations of this disclosure.

FIG. 6F provides a perspective view of a coupling base configured to couple two spring-integrated joint in accordance with some implementations of this disclosure.

FIG. 7 is a schematic view of actuation of a shape memory coil.

FIG. 8A shows a side view of a circular shape memory coil in a helical shape in accordance with some implementations of disclosure.

FIG. 8B shows a cross-sectional view of the circular shape memory coil.

FIG. 9A shows a side view of a flat shape memory coil in a helical shape in accordance with some implementations of disclosure.

FIG. 9B shows a cross-sectional view of the flat shape memory coil.

FIG. 10 is a schematic view of feedback loop system in accordance with some implementations of this disclosure.

FIG. 11 is a flowchart of an example arrangement of operations for a method for generating a command in a feedback loop system in accordance with some implementations of this disclosure.

FIG. 12 is a schematic view of haptic feedback system in accordance with some implementations of this disclosure.

FIG. 13 is a flowchart of an example arrangement of operations for a method for generating a haptic feedback signal in a haptic feedback system in accordance with some implementations of this disclosure.

FIG. 14 is a schematic view of an example computing device (e.g., data processing device) that may be used to implement the systems and methods described herein.

Like reference symbols in the various drawings indicate like elements.

### DETAILED DESCRIPTION

There is a pressing need for advanced robotic systems capable of operating in the extreme conditions often faced during land, aerospace, and marine exploration. For example, the deep sea poses unique challenges—including intense pressure, frigid temperatures, and corrosive saltwater—that often exceed the capabilities of conventional hydraulic-based systems.

This disclosure introduces electrically driven underwater manipulator systems integrated with bioinspired soft robotic grippers (also referred to as grippers) designed for underwater applications. These systems are designed to overcome the challenges posed by extreme environments, such as those encountered during deep-sea exploration, allowing for the collection and analysis of samples while minimizing or reducing environmental disturbance.

Artificial muscles power the grippers, offering superior flexibility, maneuverability, and control. Unlike the traditional hydraulic systems, which rely on fluids and complex mechanical seals prone to pressure-induced failures, electrically driven systems are more resilient. Their components can be better sealed and insulated against the corrosive and high-pressure conditions (e.g., pressure of >16,000 psi) of the deep sea, enhancing durability and reliability.

Moreover, electrically driven systems are typically lighter and more compact than the traditional hydraulic counterparts. This smaller size and reduced weight are advantageous for autonomous underwater vehicles (AUVs), human occupied vehicles (HOVs) and remotely operated vehicles (ROVs), which prioritize maneuverability and energy efficiency. Compact manipulators also facilitate access to narrow and confined spaces that are inaccessible to bulkier hydraulic systems.

These systems offer precise, delicate control mechanisms, enabling soft and accurate movements. This precision is particularly advantageous for collecting samples or interacting with fragile underwater structures. The grippers, powered by the artificial muscles, replicate the fluid, graceful motions of marine organisms, resulting in minimal or reduced environmental disturbance and preserving sensitive habitats during exploration.

Furthermore, electrically driven underwater manipulator systems demand less maintenance than the traditional hydraulic systems, especially in extreme environments. Without the need for pumps, pressure regulators, or complex fluid dynamics, these systems are more adaptable to varying underwater (e.g., oceanic) conditions, including pressure changes and temperature fluctuations. This reliability further solidifies their suitability for prolonged and challenging underwater missions.

The electrically driven underwater manipulator is a sophisticated system tailored for deep-sea exploration and research, utilizing cutting-edge bioinspired technologies to perform complex tasks in challenging underwater environments. In some implementations, the system can be powered by a fully electric drive mechanism, which eliminates or reduces the common issues associated with traditional hydraulic systems, such as fluid leaks and failures under high pressure. This allows the manipulator to function reliably in extreme conditions, including high-pressure environments found at great ocean depths, low temperatures, and corrosive saltwater settings.

In some implementations, the systems include the grippers, modeled after the soft, flexible appendages of marine organisms such as octopuses and starfish. This design allows the gripper to maneuver within confined spaces, wrap around irregularly shaped objects, and handle delicate materials without causing damage. Actuated by artificial muscles—smart materials that contract or expand in response to electrical power (e.g., current, voltage)—the gripper mimics the smooth, efficient movements of natural organisms. These artificial muscles provide the adaptability to accommodate objects of various shapes, sizes, and weights (e.g., weight up to about 25 pounds), while enabling soft, controlled movements that minimize or reduce disruption to sensitive underwater ecosystems.

In some implementations, the artificial muscles, in this disclosure, include shape memory alloys (such as shape memory coils) that return to their predetermined shape after being deformed when subjected to stimuli such as electrical power or heat. For example, 3-D printed low-temperature NiTi (Nickel-Titanium) shape memory coils can function as artificial muscles operating at a low temperatures (e.g., temperature of 4° C. or lower). Their phase transformation temperature ranges from about 1° C. to 60° C., making them well-suited for use in extremely cold environments. These artificial muscles which operate as actuators can be used to control the movement of the grippers. This actuation method is particularly well-suited for underwater operations because it requires less maintenance and is more resilient to the extreme pressures of the deep sea. The artificial muscles enable a wide range of motions, from rapid snapping movements to slow, gentle grasps, giving the manipulator the versatility to handle both rigid and fragile objects. Additionally, the electrically driven system allows for greater precision in controlling the strength and speed of each movement, which is helpful when interacting with the unpredictable and often delicate environments found in the ocean. It will be appreciated that references herein to “deep-sea” encompasses all forms of bodies of water, including deep freshwater and saltwater applications.

In some implementations, the electrically driven underwater manipulator systems feature a modular design, enabling easy replacement or upgrading of components such as the gripper, joints, or actuators as technology evolves or mission requirements change. This modularity ensures adaptability and future-proofing, allowing the system to meet the diverse demands of various underwater missions. Additionally, its compact form factor makes it ideal for integration with autonomous underwater vehicles (AUVs), human occupied vehicles (HOVs) or remotely operated vehicles (ROVs), enhancing mobility and dexterity without significantly increasing weight or power consumption. The system is also engineered to minimize or to reduce environmental impact, preserving marine habitats during exploration.

In some implementations, the electrically driven underwater manipulator systems can be controlled using a glove control mimicking user's movement. For example, in some implementations, the glove control includes motion sensors, haptic feedback actuators, and position tracking devices that detect the movements of the user's hand and fingers. The manipulator system onboard the AUV/ROV/HOV is calibrated to match the user's hand movements in real-time. This includes setting up a synchronized feedback loop between the user's glove and the manipulator's actuators, ensuring precise mimicry of the movements.

For instance, in some implementations, the vehicle carrying the manipulator is launched and descends to the required depth, with the manipulator remaining in a neutral or folded position during the descent to ensure safe transport. Upon reaching the target depth or location, the user, equipped with a motion-sensing glove, takes control of the manipulator from the control station. The manipulator arm mirrors the user's hand movements, providing precise control over its joints and the bioinspired gripper. When the user closes their fingers to grasp, the manipulator's gripper mimics this motion, actuating its artificial muscles to gently enclose around the object. The glove delivers haptic feedback, allowing the user to feel resistance when the manipulator contacts an object. This feedback helps the user gauge grip strength and make necessary adjustments, ensuring precise control while preventing damage to delicate objects or the surrounding environment.

In some implementations, the electrically driven underwater manipulator systems can be controlled using a controller such as traditional ROV controller.

For instance, in some implementations, the manipulator begins in a neutral or stowed position, ready for deployment. Upon reaching the target depth, it is powered up, allowing the pilot to take control of the system. Using a joystick or control panel within the ROV control station, the pilot operates the manipulator by individually controlling each joint. This setup enables precise adjustments to extend, rotate, or orient the arm as needed. When aligned with a target object, such as a rock sample or marine organism, the pilot carefully guides the gripper to enclose around the object using the joystick. In some implementations, integrated pressure sensors provide real-time feedback, ensuring the object is gripped with the appropriate amount of force to avoid damage.

Both methods allow for precise and adaptable control over the manipulator, with the glove-controlled option offering a more immersive, natural interaction, while the ROV pilot-controlled option provides traditional, joystick-based command of the system.

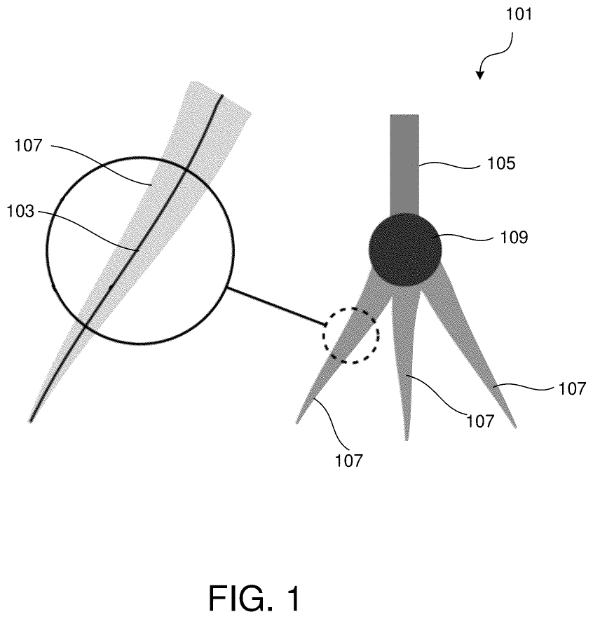

FIG. 1 illustrates a schematic view of a gripper 101 (also referred to as a bio-inspired gripper) incorporating a plurality of fingers 107 and one or more artificial muscles 103 embedded within the fingers 107 in accordance with some implementations of this disclosure.

In this example, each finger 107 includes a suitable soft material (e.g., a polymeric or elastomeric structural matrix) that is shaped to replicate a predetermined anthropomorphic finger geometry or the shape of a marine organism's appendage. As shown, one or more artificial muscles 103 (also referred to as artificial muscle actuators) are integrally embedded within the soft material of the fingers 107.

Although FIG. 1 illustrates the gripper 101 configured with three fingers 107, it is understood that the gripper 101 may alternatively be provided with at least two fingers 107, or with four or more fingers 107, without departing from the scope of the present disclosure.

The artificial muscles 103 may comprise materials such as shape memory alloys (SMAs) that return to their predetermined shape (also referred to as memorized shape or predetermined memorized shape) upon heating, including heating induced by electrical input or stimuli (e.g., an applied electrical power).

In some implementations, the artificial muscles 103 are shape-memory coils formed from wires made of one or more shape-memory alloys (SMAs). These coils may be configured as either circular or flat, depending on the desired actuation characteristics. In some implementations, the shape-memory coils include a NiTi alloy (nickel-titanium alloy). In some implementations, the shape-memory coils are made from a NiTi alloy (nickel-titanium alloy).

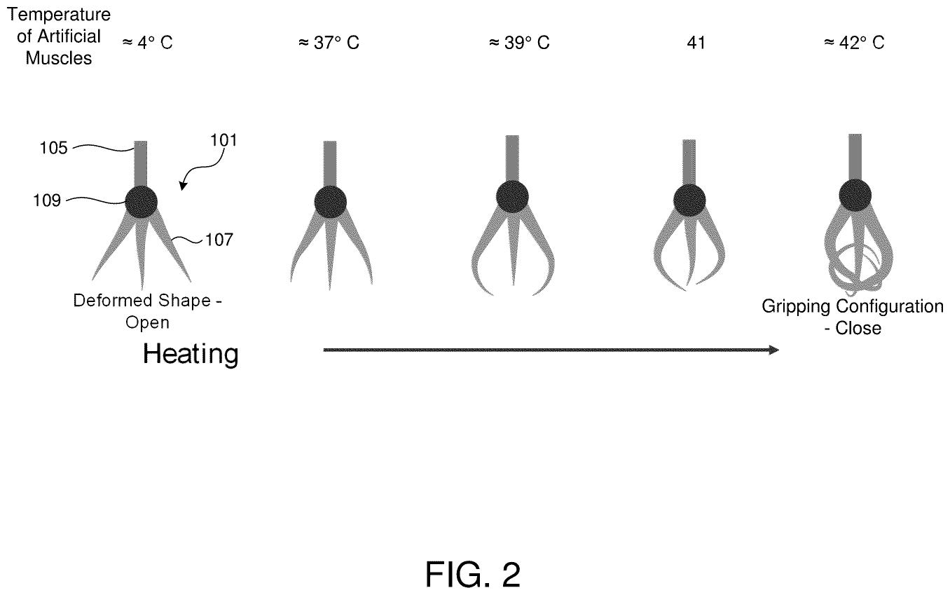

In this example, in operation, when the artificial muscles 103 are not heated, the artificial muscles 103 stay cool because of the surrounding water (or cold environment), which keeps artificial muscles 103 flexible and allows the fingers 107 to move with the water flow. When the artificial muscles 103 are heated, they recover their predetermined shape, enabling the FIG. 107 to assume a gripping configuration (shown in FIG. 2).

As illustrated, each finger 107 is joined to the linkage 105 via a joint mechanism 109. In some implementations, the joint mechanism 109 is a ball and socket joint, a spring-integrated joint, or any other suitable joint that provides the necessary degrees of freedom for finger movement.

FIG. 2 illustrates the shape change of the gripper 101 in response to changes in the temperature of the artificial muscles 103 (shown in FIG. 1).

In this example, applying electrical power (e.g., current or voltage) to the artificial muscles 103 embedded in the fingers 107 of the gripper 101 induces resistive (Joule) heating, thereby raising the temperature of the artificial muscles 103. As the temperature increases, the artificial muscles 103 recover their predetermined memorized shape, placing the fingers 107 of the gripper 101 into a gripping configuration.

As shown, in this example, the temperature of the artificial muscles 103 increases from 4° C. (which may be the temperature of surrounding environment such as water) to 37° C., the artificial muscles 103 begin to return to their predetermined shape, causing the fingers 107 of the gripper 101 to move into the gripping configuration.

When the applied electrical power to the artificial muscles 103 is removed, the artificial muscles 103 cool in the surrounding environment such as water and revert to a flexible state, allowing the fingers 107 to deform with the water flow. In cold environments (e.g., deep sea), the fingers 107 of the gripper 101 return to the flexible state more rapidly due to accelerated cooling.

In some implementations, the artificial muscles 103 comprise low-temperature shape memory alloy (SMA) that begin to return to their predetermined memorized shaped when heated to a temperature between approximately 1° C.-60° C. This differs from conventional NiTi SMA implementations that start recovering around 70° C. or greater.

In this example, the artificial muscles 103 comprise a low-temperature shape memory alloy (SMA) that begin to return to their predetermined memorized shape when heated to approximately 37°. In this example, the artificial muscles 103 include NiTi alloy. In this example, the artificial muscles 103 are configured as shape memory coils.

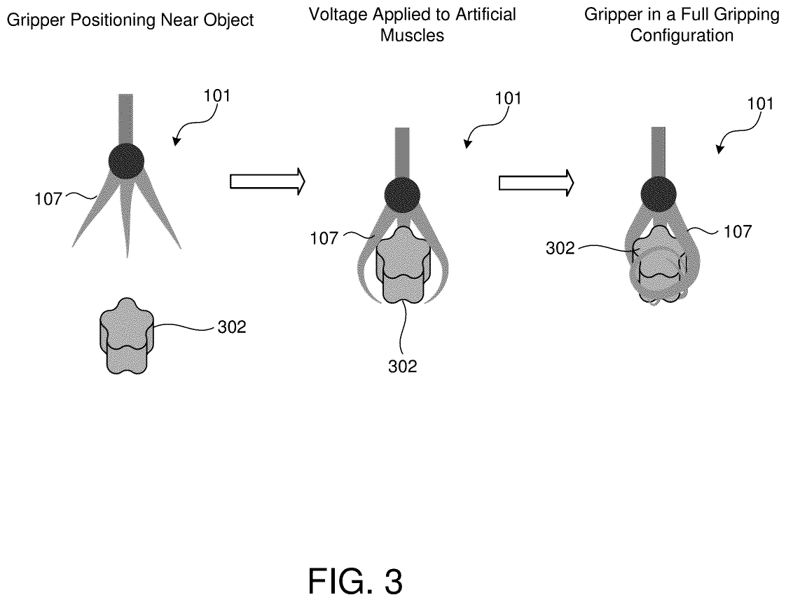

FIG. 3 illustrates a schematic of the gripper 101 configured to wrap around an object 302 (e.g., a regularly shaped object, an irregularly shaped object) for in-water sampling in accordance with some implementations of this disclosure.

As shown, the gripper 101 is operable to acquire an irregularly shaped object 302 in a deep-sea environment. Upon identifying a target (object 302 in this example), an operator positions the gripper 101 proximate to the object 302. When the fingers 107 are adjacent the object 302, an electrical power is applied to artificial muscles 103 embedded in the fingers 107 to actuate them toward a predetermined memorized shape. The actuation drives the fingers 107 to conformingly wrap around the object 302, thereby placing the gripper 101 in a full gripping configuration suitable for secure sampling and retrieval in high-pressure underwater conditions.

To release the object 302, the applied electrical power is removed from the artificial muscles 103, allowing the artificial muscles 103 to cool and transition to a flexible state, thereby permitting the fingers 107 to relax and disengage the object 302. This allows the fingers 107 to deform with the water flow.

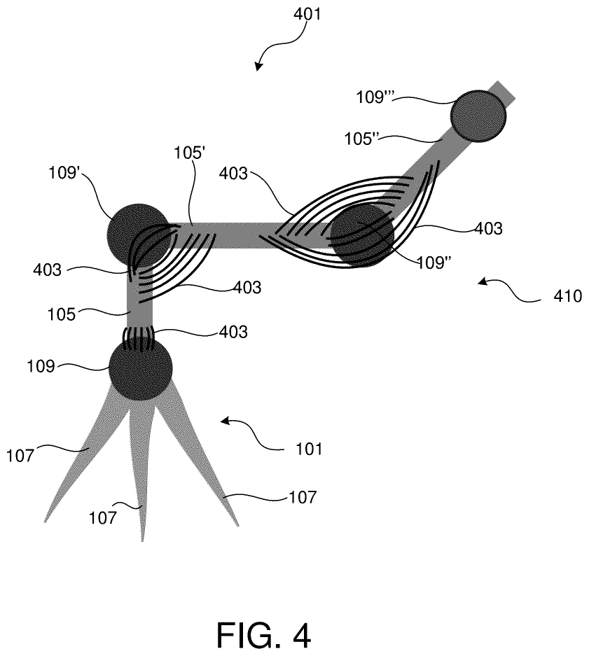

FIG. 4 illustrates an electrically driven underwater manipulator 401 configured with the gripper 101 in accordance with some implementations of this disclosure.

In some implementations, the manipulator 401 includes an arm 410 comprising a plurality of ball-and-socket joints 109 (e.g., a first joint 109, a second joint 109′, a third joint 109″, and a fourth joint 109″′) that couple multiple linkages 105 (e.g., a first linkage 105, a second linkage 105′, and a third linkage 105″). It will be appreciated that more or fewer joints than four (4) may be provided without departing from the scope of the disclosure. Artificial muscles 403 (e.g., artificial muscle 103) are operatively coupled to the arm 410 to control linkage motion and orientation. For example, one or more artificial muscles 403 may be disposed between adjacent linkages 105 joined by a ball-and-socket joint 109, or between a linkage 105 and a ball-and-socket joint 109 coupled to the gripper 101.

The artificial muscles 403 change shape in response to electrical input, such as applied electrical power, enabling selective actuation of targeted linkages 105 and, consequently, commanded movement of the arm 410. In particular, applying electrical power to the artificial muscles 403 associated with one or more specified linkages 105 produces controlled displacement about the corresponding ball-and-socket joint(s) 109.

In some implementations, applying electrical power to artificial muscles 403 embedded in the arm 410 induces resistive (Joule) heating, elevating the temperature of the artificial muscles 403. Upon heating, the artificial muscles 403 recover a predetermined shape. This may cause the artificial muscles 403 to contract, thereby shortening in length.

Such thermally driven contraction may be implemented, for example, using artificial muscles 403 configured to recover a predetermined memorized shape when heated above a transformation threshold (e.g., approximately 1° C.-60 °C).

By arranging along the arm 410 artificial muscles 403 that shorten upon activation, the system generates differential moments across the ball-and-socket joints 109 to position the linkages 105 and thereby control the motion and pose of the arm 410. This coordinated actuation enables multi-degree-of-freedom manipulation suitable for underwater operation with the gripper 101.

In some implementations, the artificial muscles 403 are configured in the same manner as the artificial muscles 103 described previously.

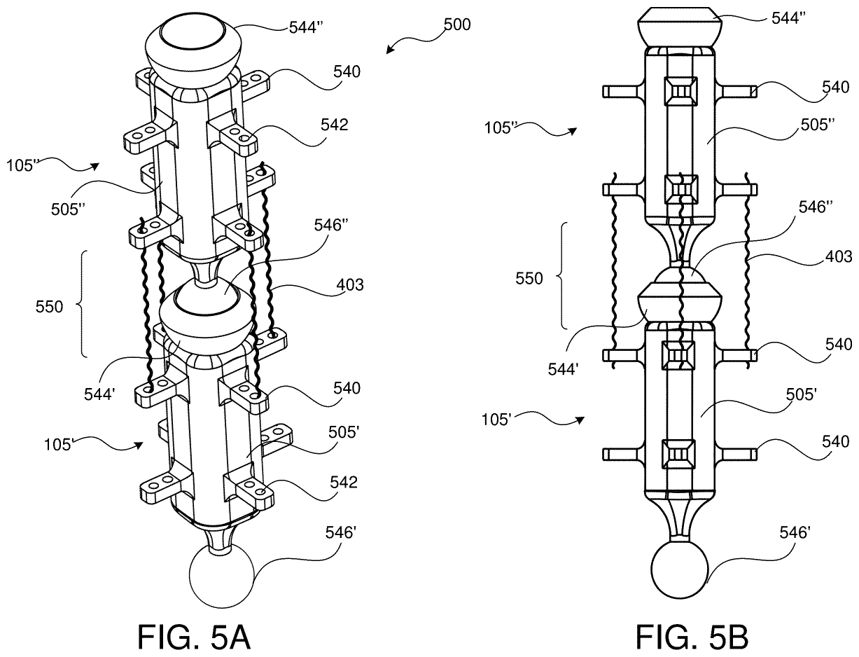

FIG. 5A and FIG. 5B illustrate an example ball-and-socket joint assembly 550 operatively coupling a second linkage 105′ to a third linkage 105″, corresponding to the linkages shown in FIG. 4. In some implementations, the joint 550 includes a socket 544′ provided on the second linkage 105′ and a ball 546″ provided on the third linkage 105″, the ball 546″ being received within the socket 544′ to permit relative articulation between the linkages 105′, 105″.

In some implementations, each linkage (e.g., the second linkage 105′ and the third linkage 105″) includes a body (e.g., body 505′, body 505″) having one or more protrusions 540 on one or more side surfaces. The protrusions 540 can serve as couplers for artificial muscles 403 or other tensile actuators. Although the illustrated bodies 505′, 505″ have a generally rectangular-prismatic form, the body geometry is not limited thereto and can alternatively be triangular-prismatic, square-prismatic, cylindrical, pentagonal-prismatic, hexagonal-prismatic, octagonal-prismatic, or any other suitable shape.

In the example shown, two protrusions 540 are provided on each side of a linkage body, with one protrusion located proximate to a ball portion of the linkage and another protrusion located proximate to a socket portion of the linkage. Accordingly, in this implementation, each linkage includes eight protrusions 540—two on each of four sides of the body. In some implementations, each protrusion 540 includes one or more coupling holes or coupling locations 542 configured to receive fasteners, fittings, or other attachment elements for securing the artificial muscles 403 between adjacent linkages.

In the illustrated configuration, four artificial muscles 403 extend between coupling locations 542 associated with the second linkage 105′ and coupling locations 542 associated with the third linkage 105″.

In the example shown, the second linkage 105′ includes the body 505′, a ball 546′ at a first end of the body 505′, and a socket 544′ at a second end of the body 505′. Likewise, the third linkage 105″ includes the body 505″, a ball 546″ at a first end of the body 505″, and a socket 544″ at a second end of the body 505″.

As illustrated, the socket 544′ of the second linkage 105′ and the ball 546″ of the third linkage 105″ are mated to establish a rotatable coupling, thereby mechanically joining the second linkage 105′ and the third linkage 105″ while allowing multi-axis relative motion.

In some implementations, the artificial muscles 403 are attached between protrusions 540 of the second linkage 105′ and protrusions 540 of the third linkage 105″ to position, actuate, and/or stabilize the linkages relative to one another. Although four artificial muscles 403 are shown, any suitable number greater than or less than four can be employed, arranged symmetrically or asymmetrically about the joint to achieve desired force vectors, redundancy, and stiffness characteristics.

During operation, the ball 546″ is received within the socket 544′ and is configured to rotate within the socket 544′ in response to selective actuation of one or more of the artificial muscles 403 extending across the joint. By independently controlling electrical power or other actuation inputs to respective artificial muscles 403, the orientation and position of the second linkage 105′ relative to the third linkage 105″ can be regulated to provide one or more commanded degrees of freedom about the joint.

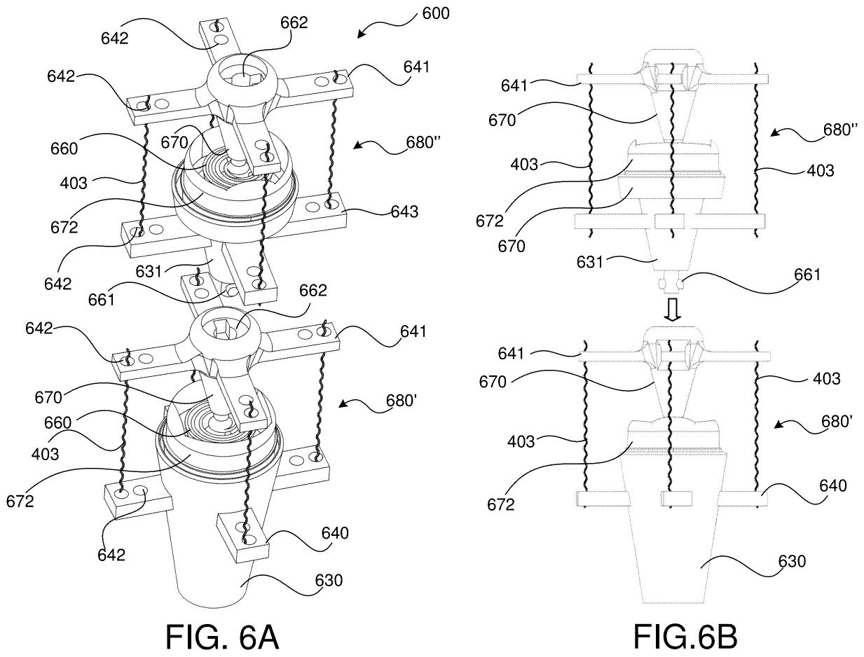

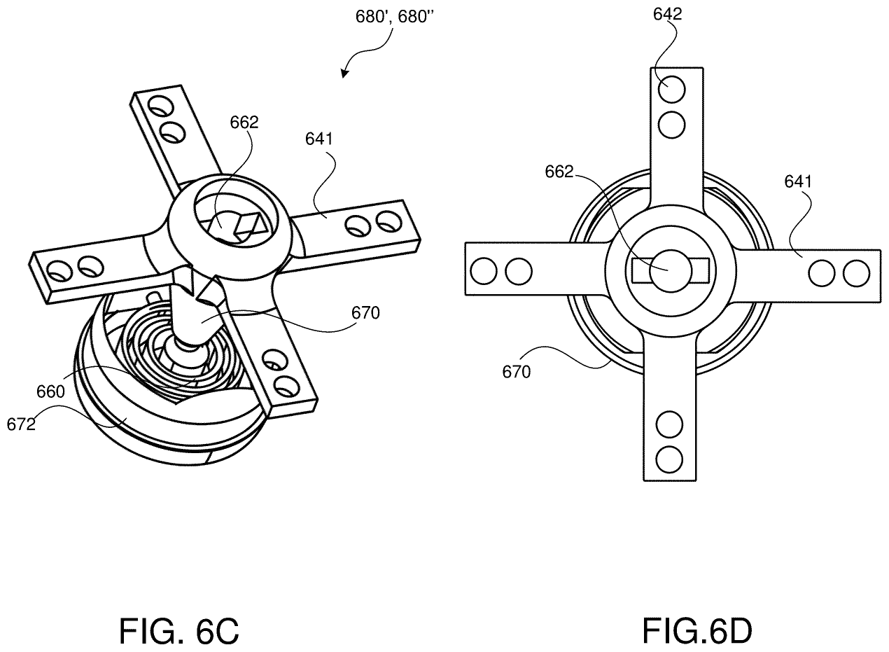

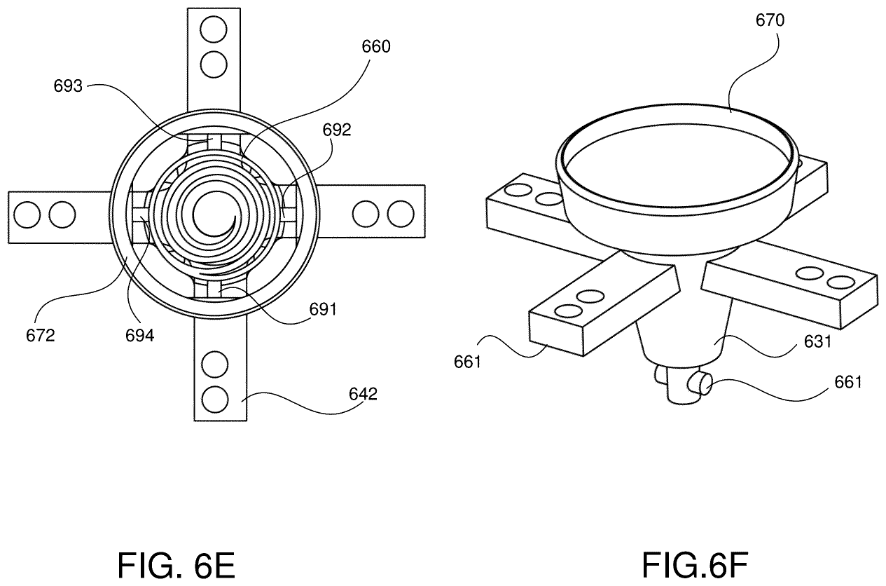

FIG. 6A is a perspective view of a portion of a manipulator 600 (also referred to as an arm) according to some implementations of the disclosure.

FIG. 6B is a side view of the portion of the manipulator 600 of FIG. 6A according to some implementations of the disclosure.

In some implementations, the manipulator 600 includes one or more spring-integrated joints. In the illustrated example, two spring-integrated joints 680′ and 680″ are provided.

In some implementations, a lower spring-integrated joint 680′ is coupled to a base 630 that includes one or more base protrusions 640 extending laterally from side surfaces of the base 630. The base protrusions 640 serve as couplers for artificial muscles 403 or other tensile actuators, and each base protrusion 640 can include one or more coupling holes or coupling locations 642 configured to receive fasteners, fittings, or other attachment elements for securing artificial muscles 403.

In some implementations, the lower spring-integrated joint 680′ includes: a standing body 670; an integrated spring 660 coupled to a first end of the standing body 670 (the center of integrated spring 660 coupled to the first end of the standing body 670 in this example); a spring housing 672 that houses the integrated spring 660; one or more protrusions 641 extending laterally from side surfaces or a second end of the standing body 670; and a coupling receiver 662 at the second end of the standing body 670. Each protrusion 641 can include one or more coupling holes or coupling locations 642 configured to receive fasteners, fittings, or other attachment elements for securing artificial muscles 403.

In some implementations, the integrated spring 660 biases and stabilizes the standing body 670 in a substantially vertical orientation with respect to the base 630.

In some implementations, artificial muscles 403 are attached between the base protrusions 640 and the protrusions 641 to further stabilize the standing body 670 in the substantially vertical orientation. Although four artificial muscles 403 are depicted, any suitable number greater than or less than four can be used, and the artificial muscles 403 can be arranged symmetrically or asymmetrically around the joint to achieve desired force vectors and redundancy.

During operation, by independently controlling electrical power or other actuation inputs to respective artificial muscles 403, the orientation and position of the standing body 670 relative to the base 630 can be regulated to provide one or more commanded degrees of freedom about the joint.

In some implementations, an upper spring-integrated joint 680″ is coupled to a coupling base 631 having one or more coupling base protrusions 643 extending laterally from side surfaces of the coupling base 631. The coupling base protrusions 643 serve as couplers for artificial muscles 403 or other tensile actuators, and each coupling-base protrusion 643 can include one or more coupling holes or coupling locations 642 configured to receive fasteners, fittings, or other attachment elements for securing artificial muscles 403.

In some implementations, the coupling base 631 includes a coupling key 661 configured to be received by the coupling receiver 662 of the lower spring-integrated joint 680′ to mechanically interface the joints.

In some implementations, the upper spring-integrated joint 680″ includes: a standing body 670; an integrated spring 660 coupled to a first end of the standing body 670 (the center of integrated spring 660 coupled to the first end of the standing body 670 in this example); a spring housing 672 that houses the integrated spring 660; one or more protrusions 641 extending laterally from side surfaces or a second end of the standing body 670; and a coupling receiver 662 at the second end of the standing body 670. Each protrusion 641 can include one or more coupling holes or coupling locations 642 configured to receive fasteners, fittings, or other attachment elements for securing artificial muscles 403.

In some implementations, the integrated spring 660 biases and stabilizes the standing body 670 of the upper spring-integrated joint 680″ in a substantially vertical orientation with respect to the coupling base 631.

In some implementations, artificial muscles 403 are attached between the coupling base protrusions 643 and the protrusions 641 to further stabilize the standing body 670 in the substantially vertical orientation. Although four artificial muscles 403 are depicted, any suitable number greater than or less than four can be used, and the muscles can be arranged symmetrically or asymmetrically around the joint to achieve desired force vectors and redundancy.

During operation, by independently controlling electrical power or other actuation inputs to respective artificial muscles 403, the orientation and position of the standing body 670 relative to the coupling base 631 can be regulated to provide one or more commanded degrees of freedom about the joint.

FIG. 6C is a perspective view of a spring-integrated joint 680′, 680″ of the manipulator 600 according to some implementations of the disclosure.

FIG. 6D is a top view of the spring-integrated joint 680′, 680″ of the manipulator 600 according to some implementations of the disclosure.

FIG. 6E is a bottom view of the spring-integrated joint 680′, 680″ of the manipulator 600 according to some implementations of the disclosure.

In some implementations, the spring 660 is secured to the spring housing 672 by a plurality of holding members 691-694. In the illustrated example, four holding members 691-694 attach the spring 660 to the spring housing 672; more than four or fewer than four holding members can be used.

FIG. 6F is a perspective view of the coupling base 631 configured with a spring-integrated joint holder 670 according to some implementations of the disclosure.

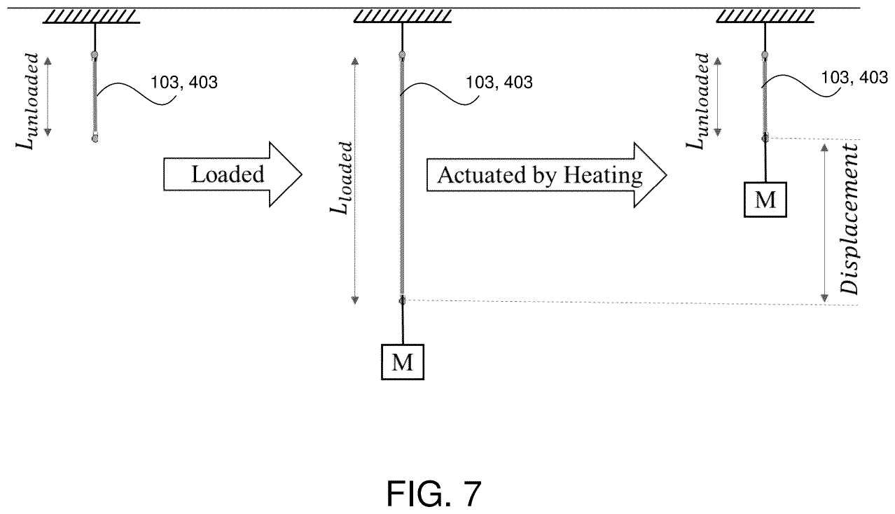

FIG. 7 schematically illustrates actuation of a shape memory coil, including a shape memory alloy (e.g., NiTi alloy), which may be employed as artificial muscles 103, 403 in accordance with some implementations of the disclosure.

Shape-memory alloys are materials that can return to a predetermined shape after deformation when exposed to a stimulus such as heat; in this example, the heat is generated by an applied electrical power. In some implementations, the shape-memory alloys may include nickel-titanium (NiTi). In some implementations, an SMA wire, including a NiTi alloy, is wound into a helical coil—resulting shape memory coil. In some implementations, the shape memory coil contracts or expands when activated up to 80% of its loaded length L_{loaded}. In this example, heat activates the shape memory coil and causes the shape memory coil to contract to its predetermined shape. This coil structure amplifies the SMA's linear motion (4% strain) and enhances its ability to produce force, making it suitable for compact actuators.

The actuation mechanism of shape memory coil is driven by a phase transformation between two crystal structures, martensite and austenite. At lower temperatures, the shape memory coil is in its martensitic phase, which is relatively pliable (flexible) and allows the material to be deformed. When the shape memory coil is heated above a critical transformation temperature (1° C.-60° C. in this example), it shifts to its austenitic phase, causing the shape memory coil to return to its pre-set or predetermined shape. In this example, this phase change leads to a rapid contraction along the axis of the shape memory coil, producing a strong pulling force. As the shape memory coil cools back down, it returns to its martensitic phase and can be deformed again, either through applied force or elastic bias mechanisms or water flow, completing a full cycle of actuation.

As shown, the alloy wire elongates when a weight M is attached, increasing its initial length L_{unloaded} to a loaded length L_{loaded}. Upon heating, for instance through an applied electrical power, the alloy wire contracts and returns to its predetermined memorized shape, reducing the loaded length L_{loaded} back to initial length L_{unloaded}. This contraction causes the weight M to move by a corresponding displacement distance.

In this example, the shape memory coil, including or composed of NiTi and used as artificial muscles 103, 403, undergo heat treatment to decrease their transformation temperature (e.g., a temperature between 1° C.-60° C.). The process may include annealing at 900° C.-1050° C. for 5-10 hours, followed by aging at 350° C.-500° C. for another 5-10 hours, and then cooling to room temperature. When NiTi shape memory coil is annealed above approximately 600° C., the transformation temperature of the NiTi shape memory coil is decreased due to the formation of Ni₃Ti or Ti₃Ni₄ precipitates and nickel enrichment within the matrix. These precipitates, along with the Ni-rich composition, lower both the martensite start and austenite finish temperatures, resulting in a low-temperature shape memory coil. Furthermore, the heat treatment promotes grain growth, while the aging stage improves reversibility by narrowing the hysteresis width and refining precipitate distribution.

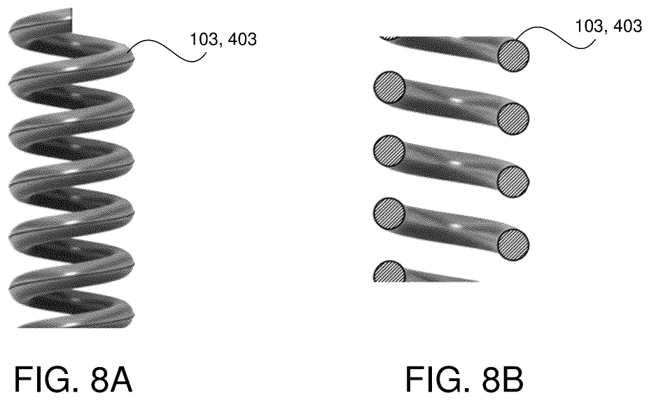

FIG. 8A shows a side view of a circular NiTi shape memory coil used as artificial muscles 103, 403 in a helical shape in accordance with some implementations of disclosure. FIG. 8B shows a cross-sectional view of the circular NiTi shape memory coil used as artificial muscles 103, 403.

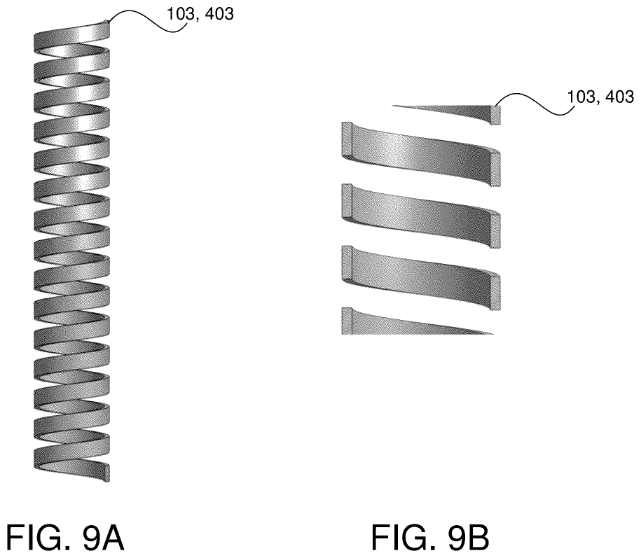

FIG. 9A shows a side view of a flat NiTi shape memory coil used as artificial muscles 103, 403 in a helical shape. FIG. 9B shows a cross-sectional view of the flat NiTi shape memory coil used as artificial muscles 103, 403.

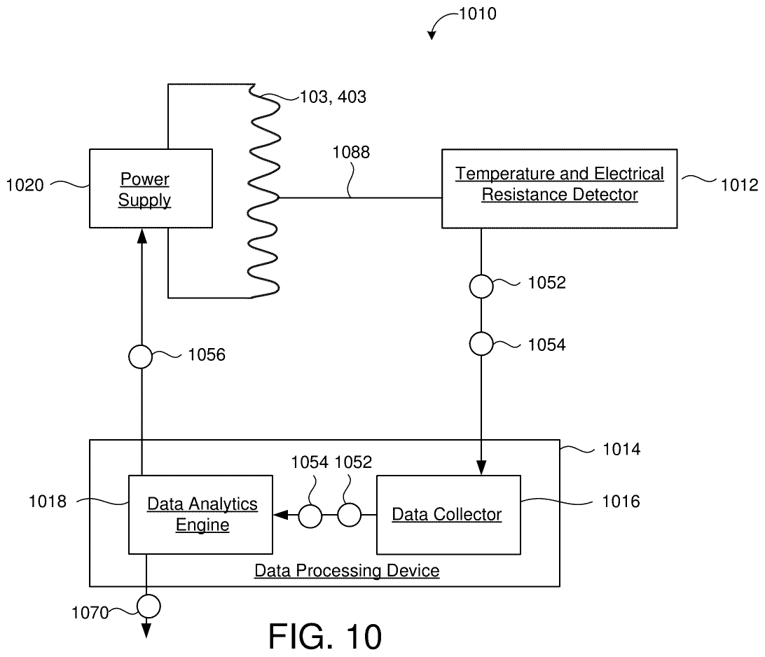

FIG. 10 is a schematic view of feedback loop system 1010 in accordance with some implementations of this disclosure.

Shape memory coils (artificial muscles 103, 403) offer valuable feedback properties that make them good candidates for sensing and controlling in actuation systems. This is due to their response during phase transformations.

When the shape memory coils transition from martensite to austenite as the temperature of the shape memory coils increases, their electrical resistance increases by about 5-10%. This change in resistance can be used as feedback (e.g., feedback metric) to determine the phase state and actuation status.

Additionally, the strain caused by the shape memory coil's contraction (typically 60-80% of the coil length) can be monitored for position control by correlating it with temperature and resistance. In applications where the shape memory coils undergo frequent actuation cycles, temperature sensors or direct thermal monitoring can help prevent overheating and keep the temperature stable.

This thermal feedback allows the shape memory coils to be cycled efficiently while ensuring energy is conserved. Moreover, the ability to sense deformation and resistance changes simultaneously enables the shape memory coils to act as “self-sensing” actuators, combining both actuation and sensing in a single element with no need for additional sensors. These capabilities make the shape memory coils particularly useful in compact, efficient control systems for robotics.

As shown, in some implementations, the feedback loop system 1010 includes a temperature and electrical resistance detector 1012 and a data processing device 1014 (e.g., computing device) including a data collector 1016 and data analytics engine 1018.

The temperature and electrical resistance detector 1012 is configured to measure temperature 1052 and electrical resistance 1054 of artificial muscles 103, 403 (low-temperature shape memory coils in this case) via one or more wires 1088. The data collector 1016 receives the temperature measurement 1052 and the electrical resistance measurement 1054 from the temperature and electrical resistance detector 1012 and forwards the measurements 1052, 1054 to the data analytics engine 1080.

The data analytics engine 1018 analyzes measurement signals 1052 and 1054 and, based on that analysis, generates and transmits a command signal 1056 to the power supply 1020 configured to provide power to the artificial muscles 103, 403 (artificial muscles 103, 403 in 10° C. water). In some implementations, the command signal 1056 instructs the power supply 1020 to increase, decrease, remove, apply, or maintain power delivered to the artificial muscles 103, 403.

In one example, when a temperature measurement 1052 received from the data collector 1016 is below the transformation temperature of the artificial muscles 103, 403 (34° C. in this example), the data analytics engine 1018 generates and transmits the command signal 1056 to cause the power supply 1020 to increase power to the artificial muscles 103, 403 to initiate a gripping operation, resulting in the fingers 107 of the gripper 101 commencing a gripping action.

In another example, when the temperature measurement 1052 is within ±X° C. of the transformation temperature (e.g., X=1 yields a 33-35° C. band in this example), the data analytics engine 1018 generates and transmits the command signal 1056 to cause the power supply 1020 to adjust power to the artificial muscles 103, 403—by decreasing, removing, maintaining, or increasing power—so that the temperature of the artificial muscles 103, 403 is regulated at the transformation temperature (34° C. in this example) for continued gripping; accordingly, the gripper 101 remains in a gripping configuration.

In a further example, when the temperature measurement 1052 is above the transformation temperature (34° C. in this example), the data analytics engine 1018 generates and transmits the command signal 1056 to cause the power supply 1020 to decrease or remove power to the artificial muscles 103, 403 such that the temperature of the artificial muscles 103, 403 remains at the transformation temperature (34° C. in this example), thereby maintaining the gripping configuration while avoiding excessive power consumption and mitigating overheating of the artificial muscles 103, 403.

In another example, when the temperature measurement 1052 is above the transformation temperature (34° C. in this example) and above a predetermined temperature (e.g., 70° C. in this example), the data analytics engine 1018 generates and transmits the command signal 1056 to cause the power supply 1020 to remove or discontinue power to the artificial muscles 103, 403 to prevent overheating of the artificial muscles 103, 403.

In some implementations, the data analytics engine 1018 analyzes the temperature and resistance measurements 1052, 1054 and, based on that analysis, generates and transmits a warning message signal 1070 to a user or system (e.g., via controller, via display, via speaker) indicating a malfunction of the artificial muscles 103, 403.

For example, when the temperature derived from the resistance measurement 1052 and the temperature measurement 1054 differ by more than A % (for example, 10%), the data analytics engine 1018 generates and sends a warning message signal 1070 to the user or system. This can help the user to locate potential malfunctioning artificial muscles.

In some implementations, the transformation temperature of the artificial muscles 103, 403 is between 1° C. and 60° C. which is lower than the conventional SMA implementation discussed above. In this example, the transformation temperature of the artificial muscles is 34° C.

Similarity, for example, when a resistance measurement 1052 received from the data collector 1016 is below a first predetermined resistance (e.g., the resistance corresponding to the transformation temperature of the artificial muscles 103, 403 (34° C. in this example)), the data analytics engine 1018 generates and transmits the command signal 1056 to cause the power supply 1020 to increase power to the artificial muscles 103, 403 to initiate a gripping operation, resulting in the fingers 107 of the gripper 101 commencing a gripping action.

In another example, when the resistance measurement 1052 falls within ±Y Ω of the resistance value corresponding to the transformation temperature, the data analytics engine 1018 generates and sends a command signal 1056 to the power supply 1020. This signal adjusts the power delivered to the artificial muscles 103, 403—by decreasing, removing, maintaining, or increasing it as needed—to regulate their resistance at the transformation resistance point (resistance corresponding to 34° C. in this example) for sustained gripping. As a result, the gripper 101 remains in the gripping state.

In a further example, when the resistance measurement 1052 is above the first predetermined resistance (e.g., the resistance corresponding to the transformation temperature of the artificial muscles 103, 403 (34° C. in this example)), the data analytics engine 1018 generates and transmits the command signal 1056 to cause the power supply 1020 to decrease or remove power to the artificial muscles 103, 403 such that the resistance of the artificial muscles 103, 403 remains at the transformation resistance point (resistance corresponding to 34° C. 34° C. in this example), thereby maintaining the gripping configuration while avoiding excessive power consumption and mitigating overheating of the artificial muscles 103, 403.

In another example, when the resistance measurement 1054 is above the transformation resistance point (resistance corresponding to 34° C. in this example) and above a predetermined resistance (e.g., resistance corresponding to 70° C. in this example), the data analytics engine 1018 generates and transmits the command signal 1056 to cause the power supply 1020 to remove or discontinue power to the artificial muscles 103, 403 to prevent overheating of the artificial muscles 103, 403.

The heat treatment process described above enables low-temperature shape memory coils incorporated in the artificial muscles 103, 403 to be engineered with transformation temperatures ranging from 1° C. to 60° C. In some implementations, the low-temperature shape memory coils utilized in the artificial muscles 103, 403 are specifically configured to have a transformation temperature of 37° C. (98.6° F.). Such a low transformation temperature facilitates operation in environments with reduced ambient temperatures, including underwater settings where temperatures may reach as low as 4° C.

In some implementations, the low-temperature shape memory coil can contract by approximately 80% of its original length upon heating.

The heating and cooling rates affect actuation speed, often around 1-2 seconds for small diameter wires, depending on thermal conditions. In some implementations, the low-temperature shape memory coil are configured to operate with actuation frequency up to 10 Hz.

In contrast, as described above, commercially available SMA actuators typically have transformation temperatures between 70° C. and 90° C., making them less suitable for deep-sea applications.

The low-temperature shape memory coils are designed with the following electrical characteristics. For example, implementing low-temperature shape memory coils as artificial muscles 103, 403 reduces power consumption from 70 W to 13 W (e.g., as low as 13 W) and energy consumption from 35 Joules to 13 Joules (e.g., as low as 13 Joules). Voltage requirements are also reduced from 24V-28V to 2V-5V (e.g., as low as 2V-5V). Additionally, the low-temperature shape memory coils are capable of more than 5000 continuous operation cycles.

In some implementations, the artificial muscles 103, 403 incorporating the low-temperature shape memory coils (e.g., NiTi low temperature shape memory coils) are configured to operate in cold environments, such as at temperatures of 10° C. or lower (for example, 4° C.). In these conditions, the artificial muscles may consume less than 70 Watts of electrical power during gripping operations. In some implementations, the artificial muscles 103, 403 may require less than 24 Volts of electrical power for the gripping operations under similar low-temperature conditions (e.g., 10° C. or lower, including 4° C.). Additionally, in some implementations, the energy consumption of the artificial muscles (e.g., reference numerals 103, 403) may be less than 35 Joules when operated in a cold environment, such as at or below 10° C. (for example, 4° C.).

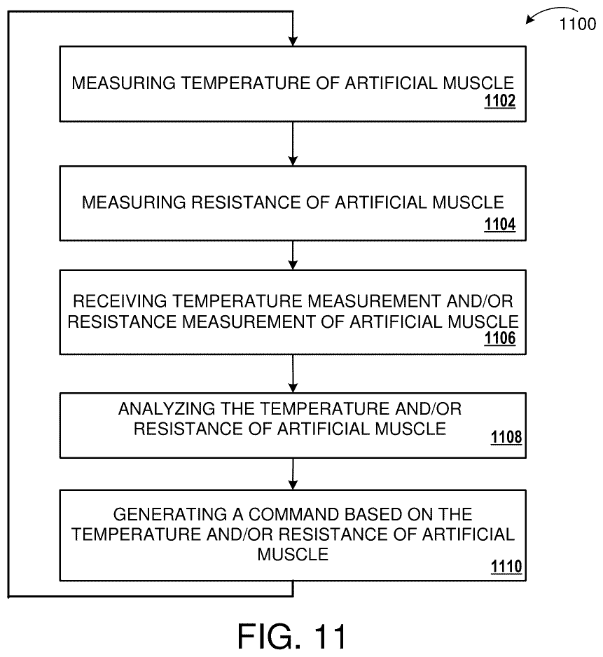

FIG. 11 is a flowchart of an example arrangement of operations for a method 1100 for generating a command 1056 in a feedback loop system 1010 in accordance with some implementations of this disclosure.

The method 1100 may be performed by a data processing device 1014 (e.g., computing device) that may include hardware (circuitry, dedicated logic, data processing hardware etc.), software (such as is run on a general purpose computer system or a dedicated machine) one memory hardware, or a combination of both, which computing device may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 1100, at operation 1102, includes measuring, by a temperature and electrical resistance detector 1012, the temperature of artificial muscle 103, 403.

The method 1100, at operation 1104, includes measuring, by the temperature and electrical resistance detector 1012, the resistance of artificial muscle 103, 403.

The method 1100, at operation 1106, includes receiving, by the data collector 1016 of the data processing device 1014, the resistance measurement 1054 of artificial muscle 103, 403 and/or the temperature measurement 1052 of artificial muscle 103, 403.

As described above, in some implementations, the feedback loop system 1010 includes the temperature and electrical resistance detector 1012 and the data processing device 1014 (e.g., computing device) including the data collector 1016 and the data analytics engine 1018. The temperature and electrical resistance detector 1012 is configured to measure temperature and electrical resistance of artificial muscles 103, 403 (low-temperature shape memory coil in this case). The data collector1018 receives the temperature measurement 1052 and the electrical resistance measurement 1054 from the temperature and electrical resistance detector 1012.

The method 1100, at operation 1108, includes analyzing (e.g., comparing) the temperature and/or resistance of the artificial muscle 103, 403. As described above, the data analytics engine 1018 analyzes the temperature and/or resistance of the artificial muscle 103, 403 from the data collector 1016.

The method 1100, at operation 1110, includes generating a command 1056 based on the temperature measurement 1052 and/or resistance measurement 1054 of the artificial muscle 103, 403. As described above, based on the analysis of the measurements 1052, 1054, the data analytics engine 1018 of the data processing device 1014 generates and transmits the signal 1056 (e.g., command) to the power supply1020 configured to provide power to the artificial muscle 103, 403. These commands 1056 may include instructions to increase, decrease, apply, remove, or maintain the power supplied to the artificial muscle.

This feedback loop system helps prevent damage to the artificial muscle from overheating. It can also prevent damage to an object by avoiding excessive gripping force.

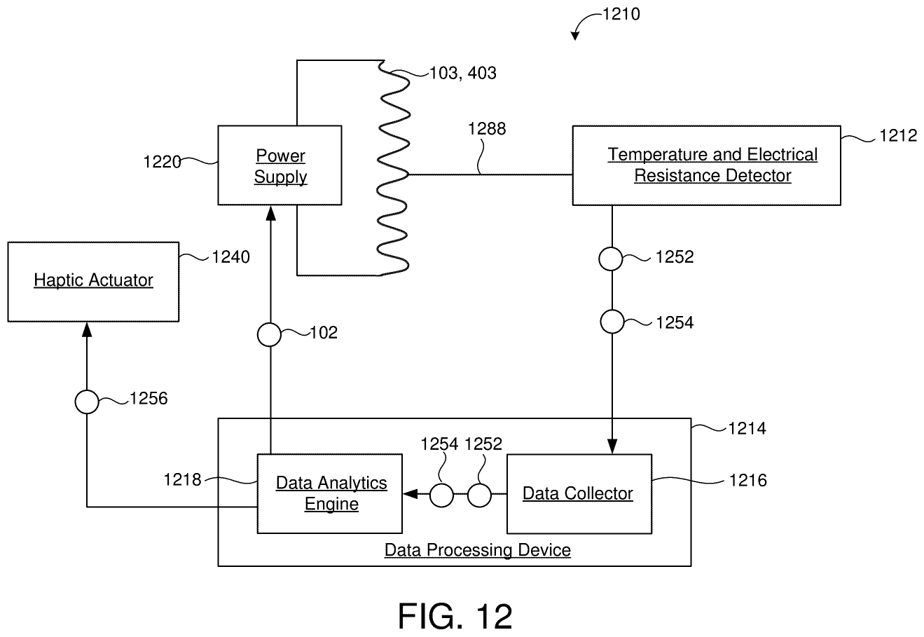

FIG. 12 is a schematic view of a haptic feedback system 1210 in accordance with some implementations of this disclosure.

Shape memory coils offer valuable feedback properties that make them good candidates for sensing and controlling in actuation systems. This is due to their response during phase transformations.

When the shape memory coils transition from martensite to austenite as the temperature of the shape memory coils increases, their electrical resistance increases by about 5-10%. This change in resistance can be used as feedback (e.g., feedback metric) to determine the phase state and actuation status.

Additionally, the strain caused by the shape memory coil's contraction (typically 60-80% of the coil length) can be monitored for position control by correlating it with temperature and resistance. In applications where the shape memory coils undergo frequent actuation cycles, temperature sensors or direct thermal monitoring can help prevent overheating and keep the temperature stable.

This thermal feedback allows the shape memory coils to be cycled efficiently while ensuring energy is conserved. Moreover, the ability to sense deformation and resistance changes simultaneously enables the shape memory coils to act as “self-sensing” actuators, combining both actuation and sensing in a single element with no need for additional sensors. These capabilities make the shape memory coils particularly useful in compact, efficient control systems for robotics.

As shown, in some implementations, the haptic feedback system 1210 includes a temperature and electrical resistance detector 1212 and a data processing device 1214 (e.g., computing device) including a data collector 1216 and data analytics engine 1218. The temperature and electrical resistance detector 1212 is configured to measure temperature and electrical resistance of artificial muscle 103, 304 (low-temperature shape memory coil in this case) via one or more wires 1288.

The data collector1216 receives the temperature measurement 1252 and the electrical resistance measurement 1254 from the temperature and electrical measurement module 1212. The data analytics engine1218 analyzes the measurements 1252, 1254. Based on analysis of the measurements 1252, 1254, the data analytics engine 1218 generates and transmits a haptic feedback signal 1256 to haptic actuator 1240 (e.g., haptic feedback actuators associated with the glove control or the traditional ROV controller). The amplitude of the haptic feedback signal 1256 increases as the temperature and/or resistance increases.

For example, when the temperature measurement 1252 is above the transformation temperature of the artificial muscles 103, 403 (34° C. in this example), the data analytics engine 1218 generates and transmits the haptic feedback signal 1256 to the haptic actuator 1240. In some implementations, the amplitude of the haptic feedback signal 1256 increases as the temperature measurement 1252 increases.

In another example, when the resistance measurement 1254 indicates that the temperature of the artificial muscle 103, 403 is above the transformation temperature of the artificial muscles 103, 403 (34° C. in this example), the data analytics engine 1218 generates and transmits the haptic feedback signal 1256 to the haptic actuator 1240. In some implementations, the amplitude of the haptic feedback signal 1256 increases as the resistance measurement 1252 increases.

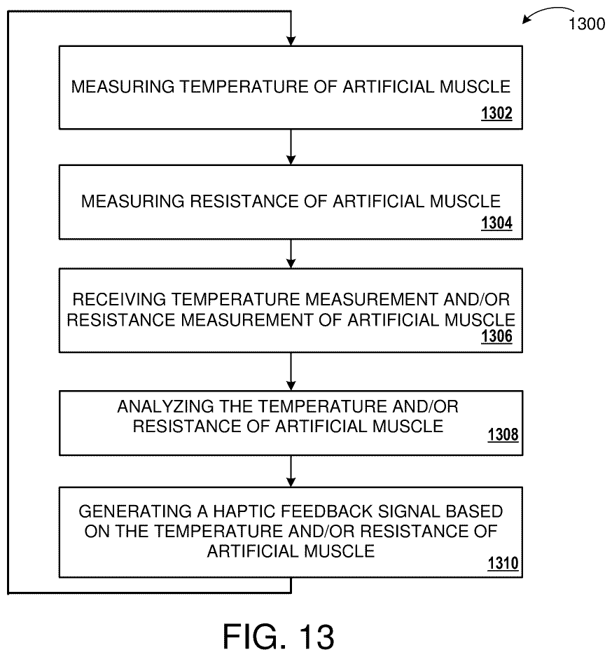

FIG. 13 is a flowchart of an example arrangement of operations for a method 1300 for generating a haptic feedback signal 1256 in a haptic feedback system 1210 in accordance with some implementations of this disclosure.

The method 1200 may be performed by a computing device that may include hardware (circuitry, dedicated logic, data processing hardware etc.), software (such as is run on a general purpose computer system or a dedicated machine) one memory hardware, or a combination of both, which computing device may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 1300, at operation 1302, includes measuring, by the temperature and electrical resistance detector 1212, the temperature of artificial muscle 103, 304.

The method 1300, at operation 1304, includes measuring, by the temperature and electrical resistance detector 1212, the resistance of artificial muscle.

The method 1300, at operation 1306, includes receiving, by the data collector 1216 of the data processing device 1214, the resistance measurement 1254 of artificial muscle 103, 403 and/or the temperature measurement 1252 of artificial muscle 103, 403.

As described above, in some implementations, a haptic feedback system includes a temperature and electrical resistance detector and a computing device (e.g., data processing device) including a data collector and data analytics engine. The temperature and electrical resistance detector is configured to measure temperature and electrical resistance of artificial muscle (low-temperature SMA in this case). The data collector receives the temperature measurement and the electrical resistance measurement from the temperature and electrical measurement module.

The method 1300, at operation 1308, includes analyzing (e.g., comparing) the temperature and/or resistance of the artificial muscle 103, 403. As described above, the data analytics engine 1208 analyzes the temperature and/or resistance of the artificial muscle 103, 403 from the data collector 1206.

The method 1300, at operation 1310, includes generating, by the data analytics engine 1208 of the data processing device 1214, the haptic feedback signal 1256 based on the temperature and/or resistance of the artificial muscle 103, 403. As described, based on the analysis of the measurements 1252, 1254, the data analytics engine 1218 generates and transmits the haptic feedback signal 1256 to the haptic device 1256. The amplitude of the haptic feedback 1256 increases as the temperature measurement 1252 and/or resistance measurement 1254 increases.

For example, when the temperature measurement 1252 from the data collector 1216 is greater than the transformation temperature of the artificial muscles 103, 403 (34° C. in this example), the data analytics engine 1218 generates and transmits the haptic feedback signal 1256 to the haptic actuator 1240. In some implementations, the amplitude of the haptic feedback signal 1256 increases as the temperature measurement 1252 increases.

In another example, when the resistance measurement 1254 from the data collector 1254 indicates that the temperature of the artificial muscles 103, 403 is above the transformation temperature of the artificial muscles 103, 403 (34° C. in this example), the data analytics engine 1218 generates and transmits the haptic feedback signal 1256 to the haptic actuator 1240. In some implementations, the amplitude of the haptic feedback signal 1256 increases as the resistance measurement 1254 increases.

Based on the haptic feedback, the user can determine that the gripper is holding the object too firm. Also, based on the haptic feedback, the user can determine that the gripper is overheating.

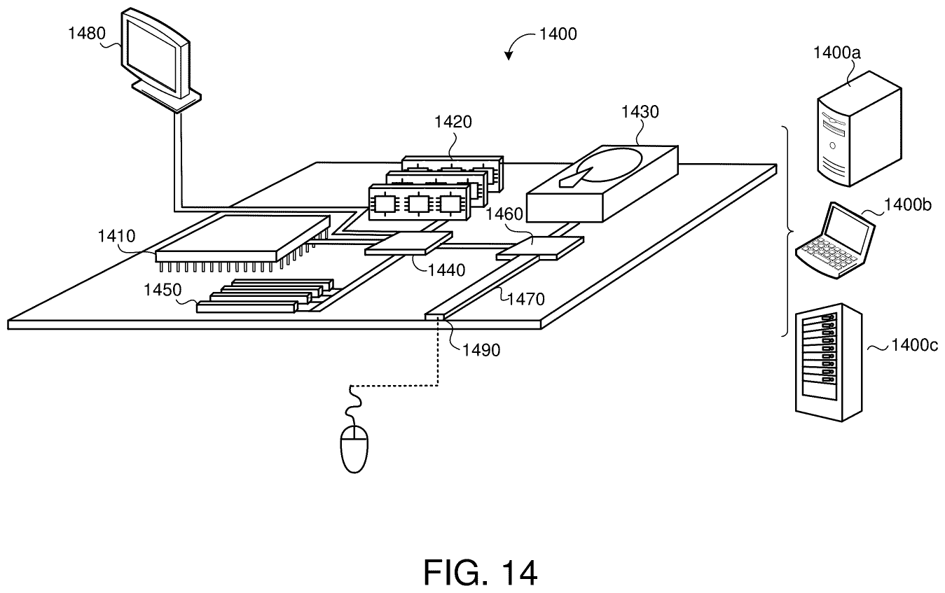

FIG. 14 is schematic view of an example computing device 1400 that may be used to implement the systems and methods described in this document. The computing device 1400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1400 includes a processor 1410, memory 1420, a storage device 1430, a high-speed interface/controller 1440 connecting to the memory 1420 and high-speed expansion ports 1450, and a low speed interface/controller 1460 connecting to a low speed bus 1470 and a storage device 1040. Each of the components 1410, 1420, 1430, 1440, 1450, and 1460, are interconnected using various busses, and may be mounted on a common motherboard or in other manners as appropriate. The processor 1410 can process instructions for execution within the computing device 1400, including instructions stored in the memory 1420 or on the storage device 1430 to display graphical information for a graphical user interface (GUI) on an external input/output device, such as display 1480 coupled to high speed interface 1440. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1420 stores information non-transitorily within the computing device 1400. The memory 1420 may be a computer-readable medium, a volatile memory unit(s), or non-volatile memory unit(s). The non-transitory memory 1420 may be physical devices used to store programs (e.g., sequences of instructions) or data (e.g., program state information) on a temporary or permanent basis for use by the computing device 1400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1430 is capable of providing mass storage for the computing device 1400. In some implementations, the storage device 1430 is a computer-readable medium. In various different implementations, the storage device 1430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 1420, the storage device 1430, or memory on processor 1410.

The high speed controller 1440 manages bandwidth-intensive operations for the computing device 1400, while the low speed controller 1460 manages lower bandwidth-intensive operations. Such allocation of duties is exemplary only. In some implementations, the high-speed controller 1440 is coupled to the memory 1420, the display 1480 (e.g., through a graphics processor or accelerator), and to the high-speed expansion ports 1450, which may accept various expansion cards (not shown). In some implementations, the low-speed controller 1460 is coupled to the storage device 1430 and a low-speed expansion port 1490. The low-speed expansion port 1490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1400 may be implemented in a number of different forms, as shown in the figure. For example, it may be implemented as a standard server 1400a or multiple times in a group of such servers 1400a, as a laptop computer 1400b, or as part of a rack server system 1400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A gripper comprising:
a plurality of fingers; and
at least one artificial muscle embedded within each of the plurality of fingers, the artificial muscle comprising at least one low temperature shape memory coil configured to recover to a memorized shape upon application of electrical power, thereby driving the fingers between an open configuration and a gripping configuration in a cold environment,
wherein the temperature of the cold environment is no greater than 4° C.

2. The gripper of claim 1, wherein:
the low temperature shape memory coil includes nickel-titanium alloy; and
the low temperature shape memory coil has a transformation temperature between approximately 1° C. and 60° C.

3. The gripper of claim 1, wherein:
the low temperature shape memory coil includes nickel-titanium; and
the low temperature shape memory coil has a transformation temperature of approximately 34° C.

4. The gripper of claim 1, wherein the fingers are configured to conformally wrap around an object upon the application of electrical power.

5. The gripper of claim 1, wherein each finger is coupled to a linkage of a manipulator through a joint.

6. The gripper of claim 5, wherein the joint is a ball-and-socket joint.

7. The gripper of claim 5, wherein the joint is a spring-integrated joint.

8. The gripper of claim 1, wherein a voltage of the electrical power is between approximately 2V and 5V.

9. The gripper of claim 1, wherein a wattage of the electrical power is less than 70 W.

10. The gripper of claim 1, further comprising a detector configured to measure a temperature and an electrical resistance of the artificial muscle, and at least one processor configured to generate a command to increase, decrease, or maintain the electrical power to the artificial muscle based on at least one of the measured temperature of the artificial muscle or the measured electrical resistance of the artificial muscle to maintain the gripping configuration.

11. The gripper of claim 1, further comprising a detector and at least one processor configured to generate a haptic feedback signal based on at least one of a measured temperature of the artificial muscle or a measured electrical resistance of the artificial muscle.

12. A feedback-control system for controlling at least one artificial muscle of a manipulator in a cold environment, comprising:
at least one processor; and a non-transitory computer-readable medium storing instructions that, when executed by the processor, cause the system to:
receive, from a detector coupled to the artificial muscle, a temperature measurement of the artificial muscle;
compare the temperature measurement of the artificial muscle to a transformation temperature of the artificial muscle; and
in response to determining that the temperature measurement of the artificial muscle is greater than the transformation temperature, generate a first control signal to a power supply that provides electrical power to the artificial muscle,
wherein the first control signal causes the power supply to decrease or discontinue electrical power delivered to the artificial muscle, and
wherein the transformation temperature is no greater than 60° C.

13. The system of claim 12, wherein in response to determining that the temperature measurement of the artificial muscle is less than the transformation temperature, generate a second control signal to the power supply that provides electrical power to the artificial muscle,
where the second control signal causes the power supply to increase electrical power delivered to the artificial muscle.

14. The system of claim 12, wherein the stored instructions, when executed by the processor, further cause the system to:
receive, from the detector coupled to the artificial muscle, a resistance measurement of the artificial muscle;
comparing the resistance measurement of the artificial muscle to a resistance value corresponding to the transformation temperature of the artificial muscle; and
in response to determining that the resistance measurement of the artificial muscle is greater than the resistance value corresponding to the transformation temperature, generating the first control signal to the power supply.

15. The system of claim 14, wherein the stored instructions, when executed by the processor, further cause the system to:
in response to determining that the resistance measurement of the artificial muscle is less than the resistance value corresponding to the transformation temperature of the artificial muscle, generating a second control signal to the power supply that provides electrical power to the artificial muscle,
where the second control signal causes the power supply to increase electrical power delivered to the artificial muscle.

16. The system of claim 12, wherein the artificial muscle includes at least one low temperature shape memory coil that includes nickel-titanium alloy.

17. A haptic feedback system for generating a haptic signal, comprising:
at least one processor; and a non-transitory computer-readable medium storing instructions that, when executed by the processor, cause the system to:
receive, from a detector coupled to an artificial muscle, a temperature measurement of the artificial muscle;
compare the temperature measurement of the artificial muscle to a transformation temperature of the artificial muscle; and
in response to determining that the temperature measurement of the artificial muscle is greater than the transformation temperature, generate the haptic signal to a haptic actuator,
wherein the transformation temperature is no greater than 60° C., and
wherein the artificial muscle includes at least one low temperature shape memory coil that includes nickel-titanium alloy.

18. The system of claim 17, wherein the stored instructions, when executed by the processor, further cause the system to:
in response to determining that the temperature measurement of the artificial muscle is greater than the transformation temperature and the temperature measurement of the artificial muscle is increasing, increase an amplitude of the haptic signal.

19. The system of claim 17, wherein the stored instructions, when executed by the processor, further cause the system to:
receive, from the detector coupled to the artificial muscle, a resistance measurement of the artificial muscle;
comparing the resistance measurement of the artificial muscle to a resistance value corresponding to the transformation temperature of the artificial muscle; and
in response to determining that the resistance measurement of the artificial muscle is greater than the resistance value, generating the haptic signal.

20. The system of claim 19, wherein the stored instructions, when executed by the processor, further cause the system to:
in response to determining that the resistance measurement of the artificial muscle is greater than the resistance value and the resistance measurement of the artificial muscle is increasing, increase an amplitude of the haptic signal.
